(19) United States
(12) Patent Application Publication
(10) Pub. No.: US 2024/0122676 A1
(43) Pub. Date: Apr. 18, 2024

(54) ENDODONTIC TOOL FOR ACTIVATING A DISINFECTANT LIQUID

(71) Applicant: LG INNOVATION S.R.L., Lioni (AV) (IT)

(72) Inventor: Gianluca PLOTINO, Roma (RM) (IT)

(21) Appl. No.: 18/264,891

(22) PCT Filed: Jun. 17, 2021
(86) PCT No.: PCT/IB2021/055364

§ 371 Date: Aug. 9, 2023

(30) Foreign Application Priority Data
Feb. 23, 2021 (IT) 102021000004196

(51) Int. Cl. A61C 5/55; A61C 17/20

(52) U.S. Cl. CPC A61C 5/55; A61C 17/20

(57) ABSTRACT

An endodontic tool for activating a disinfectant liquid sprayed in a cavity of a tooth, includes: a body, elongated along an axis and including a handgrip, for allowing an operator to hold the tool; a tip, connected to the body, configured to be immersed in the liquid; an actuator associated with the body and configured to transmit a vibration to the tip; a heater, associated with the body and configured to heat the disinfectant liquid in the tooth. The heater is designed to heat the tip and the tip is designed to heat the disinfectant liquid.

### TECHNICAL FIELD

This invention relates to an endodontic tool for activating a disinfectant liquid and a method for activating a disinfectant liquid.

### BACKGROUND ART

In particular, during the operations carried out on a tooth, it is necessary, after working on the tooth for removal of dental material, to carry out a disinfection of the dental cavity to prevent detritus from remaining but, above all, bacteria which could subsequently lead to the risk of infections, which would cancel out the effect of the work performed.

In this context, the use of a disinfectant liquid is known, which, once sprayed in the dental cavity, must be activated to increase its disinfectant effectiveness.

This activation is commonly performed using tools including a body, a tip and an actuator, which vibrates the tip at specific frequencies, for example ultrasound frequencies. The vibrations activate the liquid.

Moreover, it has been observed that an increase in the temperature of the liquid further increases the disinfectant effectiveness. For this reason, some methods involve also heating the disinfectant liquid.

However, the prior art procedures are lengthy because they require the use of two tools, used in series.

Some solutions, such as, for example, that described in patent document U.S. Ser. No. 10/363,120B2, describe a tool which also comprises a heating parallel with ultrasound vibration. However, the liquid is heated before it is sprayed, when it is still inside a tank. This reduces its effectiveness since the fluid cools again in its path towards the dental cavity and since the disinfectant capacity is partly lost due to an early activation of the fluid.

Other solutions, described in patent documents WO2013033856A1 and US2018177568A1, illustrate a heating of the fluid in combination with a vibrating tip. However, all these documents refer to a different step, namely that of removal of the dental material, and, as in patent document U.S. Ser. No. 10/363,120B2, they heat the fluid in a dedicated tank and not directly in the tooth cavity.

### Aim of the Invention

The aim of the invention is to provide an endodontic tool and a method for activating a disinfectant liquid that overcome the above mentioned disadvantages of the prior art.

Said aim is fully achieved by the endodontic tool and the method for activating a disinfectant liquid according to the invention as characterised in the appended claims.

According to one aspect of this invention, the invention provides an endodontic tool for activating a disinfectant liquid sprayed in a cavity of a tooth.

The instrument comprises a body. The body is preferably elongate along an axis. The body comprises a handgrip, to allow an operator to hold the tool.

The instrument comprises a tip. The tip is connected to the body. The tip comprises plastic material. The tip is configured for being immersed in the liquid. In other embodiments, the tip is made of metal, composite material or other material suitable for use in the endodontic sector.

The tool comprises an actuator. The actuator is associated with the body, preferably located inside it. The actuator is configured to transmit a vibration to the tip. The vibration preferably has a frequency in the ultrasound field. It is, however, possible to vibrate the tip even at subsonic or sonic frequencies.

The tool comprises a heater. The heater is associated with the body, preferably positioned inside it.

The heater is configured to heat the disinfectant liquid in the tooth.

Advantageously, the heater is configured to directly heat the tip. Moreover, the tip is configured for heating the disinfectant liquid.

This allows a direct and efficient heating between the tip and the liquid directly in the dental cavity. Consequently, the liquid is activated in the place itself which must be disinfected and maintains a high temperature for the entire time needed for the disinfection.

According to an embodiment, the tip comprises a conversion element, preferably made of (comprising a) conductive material.

According to an embodiment, the tip comprises a plastic coating. The plastic coating at least partly surrounds the conversion element. According to an embodiment, the tip is made completely of metal. Moreover, in this embodiment, the tip is configured for heating and vibrating.

The heater is configured to transmit energy to the conversion element. The conversion element is configured for converting energy into heat.

In this way, the energy generated by the heater can be transmitted to the tip which, by means of the conversion element, can convert the energy into heat, to heat the disinfectant liquid.

According to an embodiment, the conversion element is a metal filament, elongate along an axis of extension of the tip. In this embodiment, the heater is configured to generate thermal energy. The heater is associated with the metal filament to transmit heat to it by conduction.

This solution is advantageous in terms of safety, since it does not involve in any way electrical connections which could, in theoretical terms, be dangerous for the patient.

According to an embodiment, the conversion element is a U-shaped metal filament, including a first and a second end. In this embodiment, the heater comprises an electrical circuit, connected to the first and the second end of the U-shaped filament. The heater is configured to apply a current to the electrical circuit at a predetermined voltage. The U-shaped filament is configured to heat in response to the current and the voltage applied to the electrical circuit. The U-shaped filament is configured to heat by the Joule effect.

This embodiment makes it possible to have a lower heating transient as well as a greater control of the temperature. In fact, the operator might act on the heater by varying the applied current and voltage parameter, thereby varying the thermal energy developed by the Joule effect.

According to an embodiment, the transmission of heat from the heater to the conversion element occurs by irradiation. According to this embodiment, the conversion element is configured for converting the electromagnetic energy and/or the optical energy into heat.

The embodiment with radiation heating has the advantage of not requiring particular dimensions in the tip, since a compact conversion element with small dimensions is sufficient which is struck by the irradiated energy.

More specifically, the embodiment with heating by irradiation comprises a first variant, wherein the heater comprises an electromagnetic waves emitter. The tip comprises a waveguide, which extends from the emitter to the conversion element. The waveguide is configured for guiding the electromagnetic waves towards the conversion element. This ensures that the radiated waves always strike the tip, even when the latter vibrates. According to an embodiment, the waveguide is an optical fibre filament. This solution offers further advantages in terms of efficiency and reduction of overall dimensions.

The embodiment with heating by irradiation comprises a first variant, in which the heater comprises a laser configured to irradiate the conversion element. This solution is the solution which has the greatest advantages in terms of facilitating the making of the tip but may be penalised by the vibrating movement of the tip.

According to an embodiment, the tip rotates relative to the body about the axis.

According to an embodiment, the tip is configured to rotate with an oscillating rotary motion, alternating a direction of rotation. This avoids the use of electrical or thermal sliding contacts, which would adversely affect the efficiency of the tool.

According to an embodiment, the tip has a helical extension along the axis.

The rotation of the tip and its helical extension increase, both individually and in combination, the cleaning of the dental cavity because it helps to create turbulent motion and allow the contact surface with the inner walls of the cavity of the tooth to be increased.

According to another aspect, the tool comprises a tank, positioned in the body of the tool. The tank is configured to contain the disinfectant liquid. The heater is configured to preheat the liquid inside the tank and to heat the tip.

The tip, according to this embodiment, comprises a dispensing channel, elongate along the axis A. The dispensing channel is configured for conveying the disinfectant liquid into the cavity of the tooth. The tool is configured for dispensing the disinfectant liquid, from the tank to the cavity of the tooth, using the dispensing channel. Moreover, the heated tip is configured to heat the disinfectant liquid whilst it is dispensed and, subsequently, even when it is positioned inside the dental cavity. According to this embodiment, it is therefore possible to minimise the necessary tools, using a single tool for dispensing and activating, and it is also possible to maintain a constant and high heating and, consequently, have a very high disinfectant efficiency.

According to one aspect of the invention, the invention also provides a method for activating a disinfectant liquid sprayed in a cavity of a tooth.

The method comprises a step of preparing an endodontic tool comprising a body, a tip, connected to the body, an actuator and a heater.

The method comprises a step of immersion of the tip in the disinfectant liquid.

The method comprises a step of vibrating the tip using the actuator.

The method comprises a step of heating the disinfectant liquid.

Advantageously, the step of heating the disinfectant liquid comprises a first heating step, wherein the heater heats the tip. The heating step comprises a second heating step, wherein the tip transfers the heat to the disinfectant liquid.

### BRIEF DESCRIPTION OF THE DRAWINGS

These and other features will become more apparent from the following detailed description of a preferred embodiment, illustrated by way of non-limiting example in the accompanying drawings, in which:

FIG. 1 schematically illustrates an endodontic tool according to the invention;

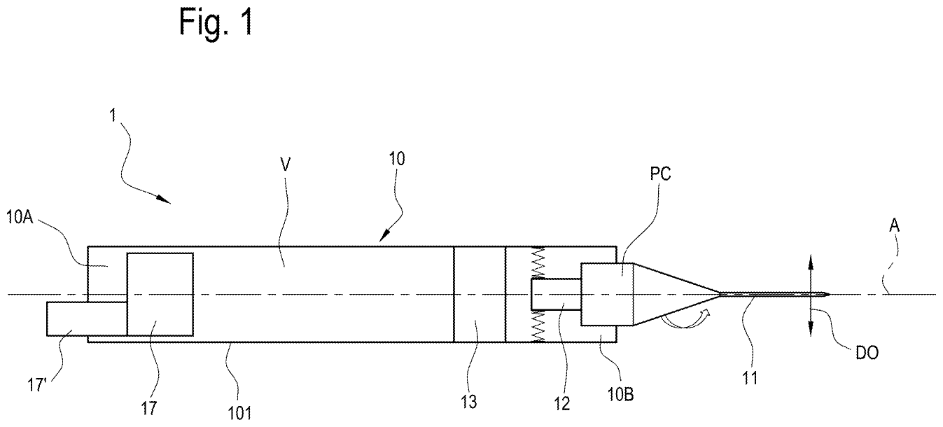

FIG. 2 illustrates a detail of a second embodiment of the endodontic tool of FIG. 1;

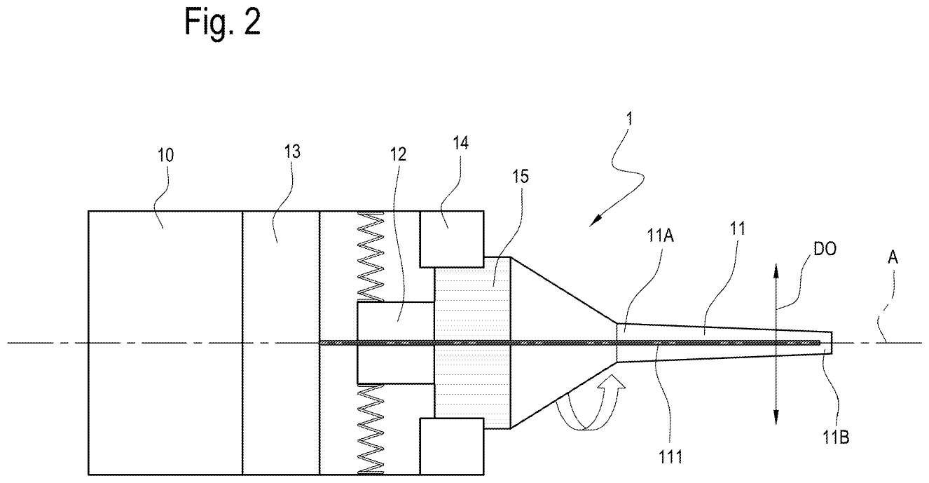

FIG. 3 illustrates a detail of a third embodiment of the endodontic tool of FIG. 1;

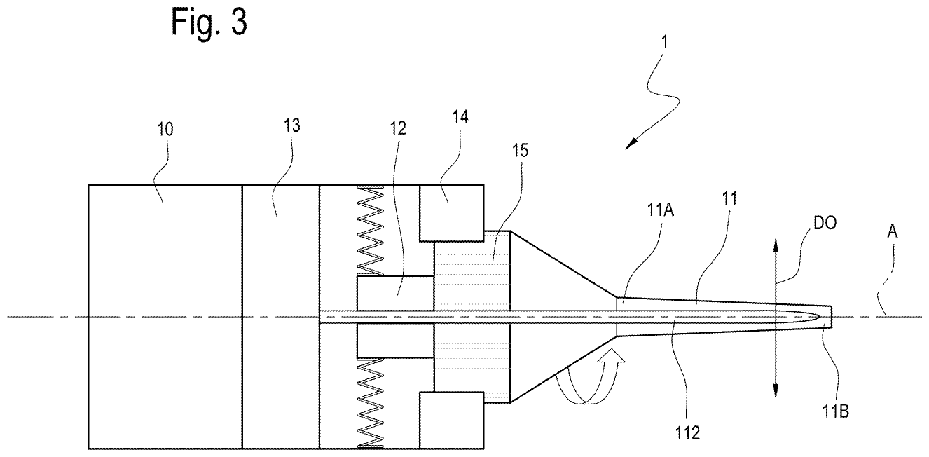

FIG. 4 illustrates a detail of a fourth embodiment of the endodontic tool of FIG. 1;

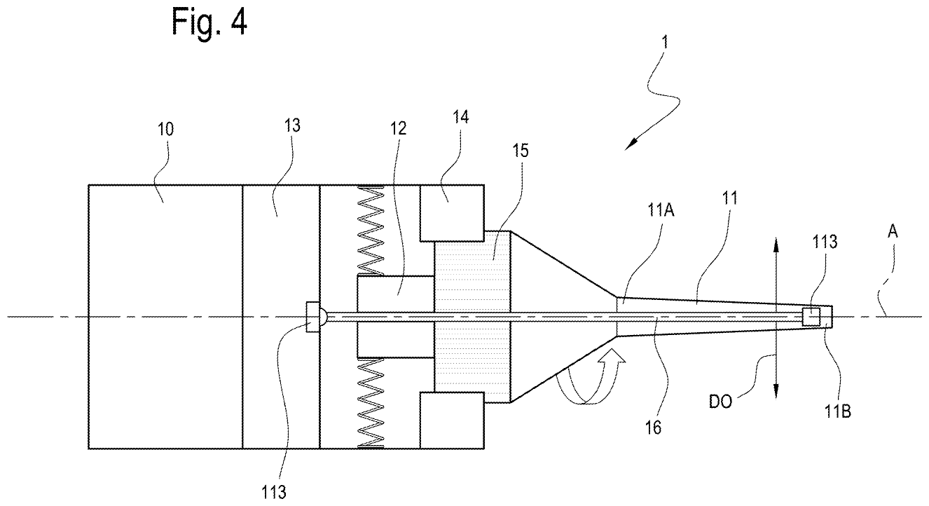

FIG. 5 illustrates a detail of a fifth embodiment of the endodontic tool of FIG. 1.

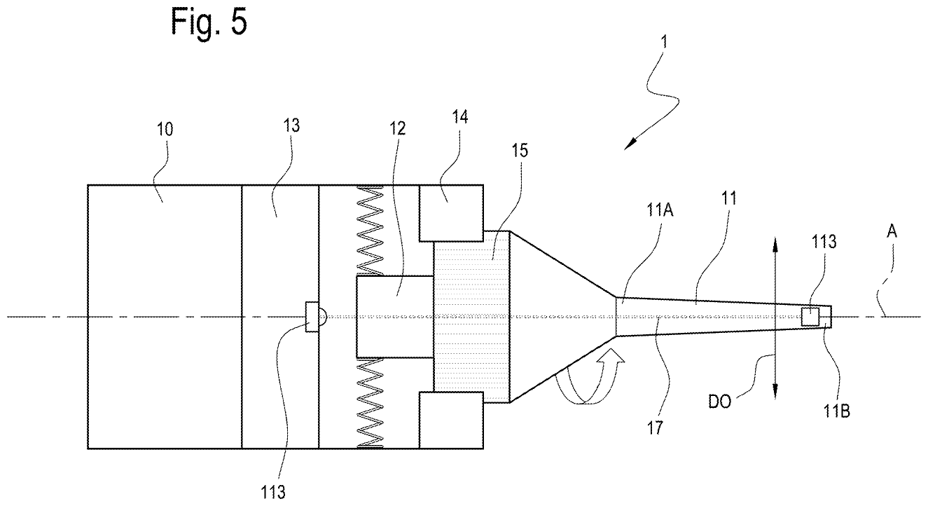

### DETAILED DESCRIPTION OF PREFERRED EMBODIMENTS OF THE INVENTION

With reference to the accompanying drawings, the numeral 1 denotes an endodontic tool for activating a disinfectant liquid, which was previously sprayed in a cavity of a tooth.

The instrument 1 comprises a body 10. The body 10 is preferably cylindrical in shape, elongate along an axis A.

The body 10 is preferably hollow to define an internal space V. The body 10 comprises a first end 10A and a second end 10B.

The tool 1 comprises a tip 11. The tip 11 is connected to the body 10.

The tool 10 also comprises a connecting portion PC interposed between the body 10 and the tip 11 to allow them to be connected.

The tip 11 is preferably elongate along the axis A between a first end 11A and a second end 11B. The second end 10B of the body 10 is connected to the connecting portion PC. The first end 11A of the tip 11 is connected to the connecting portion PC.

The tip 11, according to an embodiment, is made of plastic material. According to other embodiments, the tip 11 comprises plastic material but also includes further materials, for example the above-mentioned metallic material.

According to an embodiment, the tip 11 is movable relative to the body 10. More specifically, the tip 11 is configured to oscillate (vibrate) relative to the body 10. According to some embodiments, the tip 11 can also rotate relative to the body 10.

The tool 1 comprises a vibration actuator 12 configured to move the tip 11 relative to the body 10. The vibration actuator 12 is configured to vibrate the tip 11 along a direction of oscillation DO, perpendicular to the axis A. According to other embodiments, the direction of oscillation DO is parallel to the axis A.

Lastly, according to some embodiments, the direction of oscillation DO may include a component parallel to the axis A and a component perpendicular to the axis A. According to an embodiment, the tool 1 comprises a rotary actuator 14, which is connected to the body 10.

According to an embodiment, the connecting portion PC comprises a coupling profile 15, for example a gear wheel, configured for engaging in corresponding gear wheels of the rotary actuator 14.

In this way, since the tip 11 is integral in rotation with the connecting portion PC, the tip 11 is set in rotation by the rotary actuator 14.

Two combined solutions can be provided in the presence of the vibrational actuator 12 and the rotary actuator 14. According to a first embodiment, the rotary actuator is connected to the body 10 and also sets the vibrational actuator 12 in rotation, which rotates as one with the tip 11 and causes it to oscillate.

According to an alternative embodiment, on the other hand, the vibration actuator 12 is connected to the body 10 and also oscillates the rotary actuator 14 which, in turn, causes the tip 11 to rotate about the axis A.

In one embodiment, the instrument 1 comprises a heater 13. The heater 13 is configured to heat the tip 11 of the tool, which consequently heats the disinfectant liquid in the cavity of the tooth.

Preferably, the heater 13 and the vibrational actuator 12 are configured to heat and vibrate the tip simultaneously. According to other embodiments, the tip 11 is also heated and vibrated in two successive steps. According to an embodiment, the heater 13, the rotary actuator 14 and the vibration actuator 12 are configured for heating, rotating the tip 11 about the axis A and simultaneously vibrating the tip 11. This embodiment offers the greatest advantages in terms of efficiency of cleaning and disinfection.

According to an embodiment, the heater 13 is an electric heater, where a heating element is overheated by the passage of current. According to other embodiments, the heater 13 is a wave emitter (of light or laser).

The methods by which the heater 13 heats the tip 11 may vary according to operating requirements. Some embodiments are introduced below purely by way of a non-limiting example.

According to a first embodiment, the heat exchange between the heater 13 and the tip is accomplished by conduction of heat.

According to this embodiment, the tip 11 comprises a metal core 111. The metal core 111 is partly surrounded by plastic material, to prevent direct contact of the hot core with the tooth. If the material is metallic, however, the tooth is heat resistant and can withstand thermal stress.

The metal core 111 is connected (thermally) to the heater 13 to receive from the latter heat by conduction. More specifically, according to an embodiment, the metal core 111 extends up to the resistance of the heater 13, removing heat from the latter, which transfers firstly to the polymeric coating and then to the disinfectant liquid.

According to a second embodiment, the tip 11 comprises a U-shaped core 112, made of electrically resistant material. In other words, according to this embodiment, the U-shaped core 112 acts as the resistance of the heater 13 increasing the heat exchange efficiency as well as the control of the temperature of the tip 11. The U-shaped core 112 comprises two ends which are connected to an electric circuit inside the heater 13.

According to an embodiment, the heater 13 comprises an emitter 131. The emitter 131 is configured for emitting a laser beam and/or electromagnetic waves at a certain wavelength. According to an embodiment, the tip 11 comprises a conversion element 113, configured to receive energy from the heater 13 and to convert it into heat.

According to a third embodiment, the tool 1 comprises a waveguide 16, which extends from the emitter 131 to the conversion element 113. For this reason, the electromagnetic waves emitted by the emitter 131 are conveyed towards the conversion element 113, which consequently heats, causing the consequent heating of the disinfectant liquid. The waveguide preferably comprises an optical fibre.

Lastly, in a last variant, wherein the emitter 131 is a laser emitter, the laser 17 irradiates the conversion element 113 heating it without the need for a waveguide.

According to an embodiment, the tip 11 is helical in shape. According to an embodiment, the tip 11 comprises a plurality of micro-tips, projecting radially relative to the axis A and branched by a central body of the tip.

According to an embodiment, the tool 1 comprises an electricity supply unit 17 configured to power the vibrational actuator 12, the heater 13 and the rotary actuator 14. According to other embodiments, the tool 1 comprises a power cable 17′, connected to an external electricity supply. In these embodiments, the power supply unit 17 may be kept as a buffer battery.

Lastly, the tool 1 comprises a control unit and a user interface. The user interface comprises a plurality of control pushbuttons, the selection of which determines the sending to the control unit of configuration signals.

The control unit is configured for processing the configuration signals, for generating control signals, in response to the configuration signals.

The control unit is configured to send the control signals to the heater 13 for varying the temperature of the tip.

The control unit is configured for sending the control signals to the vibration actuator 12 for varying the vibration parameters, for example the frequency.

The control unit is configured to send the control signals to the rotary actuator 14 to vary a speed of rotation and/or a direction of rotation of the tip 11.

1. An endodontic tool for activating a disinfectant liquid sprayed in a cavity of a tooth, comprising:
a body, elongated along an axis and including a handgrip, for allowing an operator to hold the tool;
a tip, connected to the body and configured to be immersed in the liquid;
an actuator associated with the body and configured to transmit a vibration to the tip;
a heater, associated with the body and configured to heat the disinfectant liquid in the tooth,
characterised in that the heater is designed to heat the tip and wherein the tip is designed to heat the disinfectant liquid.

2. The endodontic tool according to claim 1, wherein the tip comprises:
a conversion element configured to convert energy into heat;
a plastic coating, at least partly surrounding at least partly the conversion element.

3. The endodontic tool according to claim 2, wherein the heater is configured to transmit energy to the conversion element and wherein the conversion element is configured to convert the energy received from the heater into heat.

4. The endodontic tool according to claim 3, wherein the conversion element is a metal filament, elongate along the axis and wherein the heater is associated with the metal filament for transmitting heat by conduction.

5. The endodontic tool according to claim 3, wherein the conversion element is a U-shaped metal filament, including a first and a second end, and wherein the heater comprises an electric circuit, connected to the first and the second end of the U-shaped filament, and wherein the U-shaped filament is configured to heat by the Joule effect.

6. The endodontic tool according to claim 3, wherein the transmission of heat from the heater to the conversion element occurs by irradiation and wherein the conversion element is configured to convert the electromagnetic energy or the optical energy into heat.

7. The endodontic tool according to claim 6, wherein the heater comprises an emitter of electromagnetic waves and wherein the tool comprises a waveguide, which extends from the emitter to the conversion element and is configured to guide the electromagnetic waves towards the conversion element.

8. The endodontic tool according to claim 7, wherein the waveguide is an optical fibre filament.

9. The endodontic tool according to claim 6, wherein the heater is configured to emit a laser, configured to irradiate the conversion element.

10. The endodontic tool according to claim 1, wherein the tip rotates relative to the body about the axis.

11. The endodontic tool according to claim 10, wherein the tip is configured to rotate with an oscillating rotary motion, alternating a direction of rotation.

12. The endodontic tool according to claim 1, wherein the tip extends in a helical fashion along the axis.

13. A method for activating a disinfectant liquid sprayed in a cavity of a tooth, the method comprising the following steps:
preparing an endodontic tool comprising a body, a tip connected to the body, an actuator and a heater;
immersing the tip in the disinfectant liquid;
vibrating the tip by means of the actuator;
heating the disinfectant liquid,
characterised in that the step of heating the disinfectant liquid comprises a first heating step, wherein the heater heats the tip, and a second heating step, wherein the tip transfers the heat to the disinfectant liquid.
